(19) United States
(12) Patent Application Publication
(10) Pub. No.: US 2022/0248326 A1
(43) Pub. Date: Aug. 4, 2022

(54) SIDE LINK ESTABLISHMENT FOR LOW POWER DEVICES

(71) Applicant: IPCom GmbH & Co. KG, Pullach (DE)

(72) Inventors: Andreas SCHMIDT, Braunschweig (DE); Achim LUFT, Braunschweig (DE); Maik BIENAS, Schöppenstedt (DE); Martin HANS, Bad Salzdetfurth (DE)

(73) Assignee: IPCom GmbH & Co. KG, Pullach (DE)

(21) Appl. No.: 17/619,267

(22) PCT Filed: Jul. 10, 2020
(86) PCT No.: PCT/EP2020/069575

§ 371 Date: Dec. 15, 2021

(30) Foreign Application Priority Data
Jul. 12, 2019 (EP) 19185993.3

(51) Int. Cl. H04W 52/02; H04W 76/14; H04W 88/04

(52) U.S. Cl. CPC H04W 52/0216; H04W 88/04; H04W 76/14

(57) ABSTRACT

The present invention provides a method of selecting a UE device to act as a relay between an internet connected server and a remote UE device, the method comprising: at a time determined by a knowledge of when the remote UE device will enter an active state identifying one or more UE devices in a vicinity of a known location of the remote UE device which are able to act as relay devices; selecting one or more of the identified UE devices to establish a connection with the remote UE device; and instructing the one or more selected UE devices to establish a connection with the remote UE device to provide the relay.

The present invention relates to establishing a connection between two user equipment, UE, devices in a mobile communications system.

In 3GPP several use cases for relays for energy efficiency and extensive coverage are currently being discussed. In this work item named “Enhanced Relays for Energy eFficiency and Extensive Coverage”, REFEC, different domains (e.g. inHome, SmartCities, SmartFarming, SmartFactories, Smart Energy, Public Safety, Logistics) are being considered. The present invention is concerned in particular with low-power internet-of-things (IoT) devices in areas without cellular coverage. One example is a smart meter for water consumption in the basement of a residential building. The resident might be an elderly person without a smartphone. There is no gateway for smart metering in the building. Especially for battery powered devices like a smart meter it is beneficial if the connectivity is not based on opportunistic networking, because the permanent search for an appropriate UE to network relay consumes battery power fast. It would be beneficial to orchestrate the UE to network relaying in order to save battery power.

3GPP has specified ProSe services; a direct device to device communication between UEs in proximity. Part of the specifications are different methods for device discovery and sidelink (direct link between two devices) establishment.

In ProSe single-hop UE to network relays are specified, whereas eProSe extends single-hop UE to network relays to multi-hop chains of relays. In 3GPP TR 22.866 REFEC service requirements for multi-hop UE to network chain of relays are specified.

3GPP document RP-191226 entitled “Study on NR sidelink for home IoT” presented to TSG RAN Meeting #84, Jun. 3-6, 2019 refers to the use of sidelink connections for IoT devices rather than Wi-Fi with a view to power saving. 3GPP document RP-172735 discusses UE-to-network relaying for IoT devices and 3GPP document R2-153764 LTE/ProSe relay activation.

US 2018/0255505 A1 describes methods, devices, systems, techniques, and computer program products in which an eNB, within a wireless communications network, determining network coverage status relating to a cell served by it, where the eNB supports UE-to-Network relay for a remote UE using direct device-to-device communication between the remote UE and a relay UE connected to the serving cell. Based on a determination of network coverage status, at least one UE is initiated and selected to act as a relay UE. The radio interface link quality of the relay UE can be evaluated, and the relay UE can be configured to send an indication of the radio interface link quality to the remote UE. Based on the determined network coverage status and selection of a relay UE, the remote UE is controlled by the eNB for the relay UE discovery and selection either directly or via the relay UE.

WO 2016/182597A1 discloses a technology for a relay user equipment (UE) operable to act as a relay between a remote UE and an eNodeB. The relay UE can receive, from the eNodeB, a relay configuration message that includes one or more relay configuration parameters. The relay UE can identify relay UE information associated with one or more relay parameters of the relay UE. The relay UE can determine to act as the relay for the remote UE based on the one or more relay configuration parameters and the relay UE information. The relay UE can transmit a discovery message to the remote UE in order to establish a direct connection between the relay UE and the remote UE, wherein the relay UE is configured to relay data from the eNodeB to the remote UE via the direct connection between the relay UE and the remote UE.

Over-the-top (OTT) applications are solutions that are implemented on top of the cellular infrastructure or rather on top of TCP/IP. Most OTT applications use HTTP as a transport protocol. IoT service providers commonly use OTT solutions to connect IoT devices. An application for mobile devices is developed and deployed for the communication between IoT application server and IoT device. The application establishes a connection from the mobile device to the IoT device via a short range communication (e.g. Bluetooth, WLAN, NFC) or via cellular device to device communication (e.g. 3GPP ProSe). Data between an IoT application server and an IoT device are proxied by the OTT application.

An application programming interface (API) is a set of programming code that queries data, parses responses, and sends instructions between one software platform and another.

OTT applications are expensive solutions. Development, maintenance, and deployment of applications for several mobile device platforms is a considerable cost factor. User interaction is needed. Users have to download, install, and run the application on their mobile devices. A significant number of users is not able or not willing to use the corresponding OTT applications. Only mobile devices that have the corresponding applications currently running, are able to establish a connection to the IoT device in proximity.

If IoT-devices had their own internet connectivity even in areas without or with insufficient cellular coverage via transparent UE to network relays, IoT service provider could save the costly effort of OTT solutions and could ensure a much better user experience to their IoT users.

There is no known disclosure of a kind of opportunistic orchestration of remote UE and relay UE scenarios. The 3^{rd}-party service provider for IoT services like reading smart meters has no information about potential relay UEs in proximity of the IoT despite relay UEs that are registered to the IoT service. On the other hand, the 3^{rd}-party service provider has detailed information about position and configuration of IoT devices belonging to his IoT service. The PLMN operator has no information about the position, connectivity and configuration settings like wake-up timing parameters of IoT devices not operated by PLMN operator but on the other hand the PLMN operator has detailed information about potential relay UEs, including position, connectivity, capabilities, authorization and configuration.

The present invention provides a method of selecting a UE device to act as a relay between an internet connected server and a remote UE device, the method comprising: at a time determined by a knowledge of when the remote UE device will enter an active state identifying one or more UE devices in a vicinity of a known location of the remote UE device which are able to act as relay devices; selecting one or more of the identified UE devices to establish a connection with the remote UE device; and instructing the one or more selected UE devices to establish a connection with the remote UE device to provide the relay.

The invention further provides a smart meter having an internet-of-things communication module, wherein the communication module is programmed to enter an active state from a sleep state at a predetermined time, establish a connection with a relay user equipment device, and transmit data to a service provider via the relay user equipment device.

The invention may be considered to have the following three aspects.

Firstly, a method of finding and selecting relay UEs to enable a connection between a 3rd party server and a remote UE via a sidelink communication between the relay UE and the remote UE; secondly, a method of enabling an encrypted direct message exchange (sidelink connection) between a remote UE and an un-paired relay UE with simultaneous consideration of shared information between a 3^{rd}-party IoT service provider and a PLMN operator; and thirdly, a method of enabling information exchange between a 3^{rd}-party IoT service provider and a PLMN operator. In a direction from the IoT service provider to the PLMN operator information about position and other configuration data of IoT devices could be provided. In the other direction from the PLMN operator to the IoT service provider information about possible relay UEs in proximity and statistics about availability of UE to network relays thru the day, week, or month. Only anonymous information exchange ensures privacy of users of IoT devices and users of UEs in proximity of IoT devices.

Offering the three methods described above, is beneficial to both PLMN operators and 3^{rd}-party IoT service providers. PLMN operators are enabled to use information about UEs registered to their cellular networks in order to offer new services to 3^{rd}-party IoT service providers. IoT service providers or users of IoT devices are enabled to use a multi-hop chain of UE to network relays offered by PLMN operators as a service in order to establish connectivity to low-power IoT devices out of cellular coverage. The IoT service provider could consider to forbid lot users from developing and deploying their own application.

Preferred aspects of the invention will now be described, by way of example only, with reference to the accompanying drawings in which:

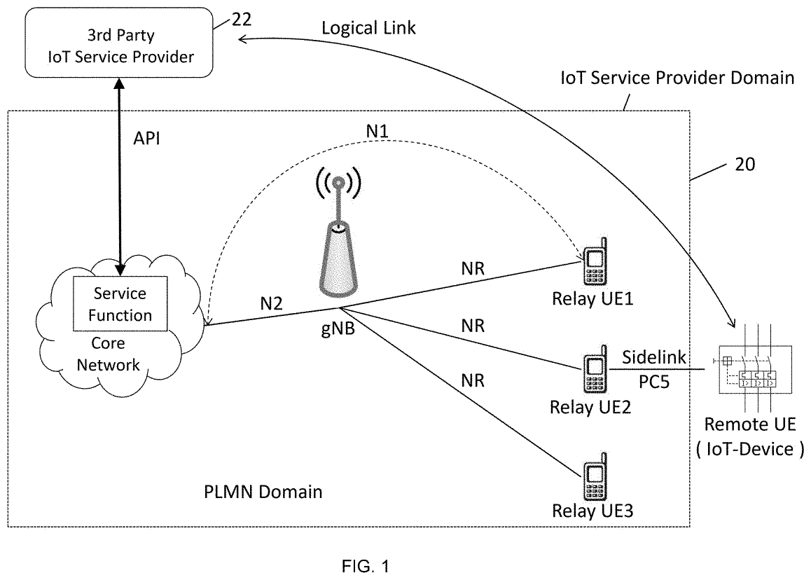

FIG. 1 shows an example of a connection to a remote UE being provided by a relay device; and

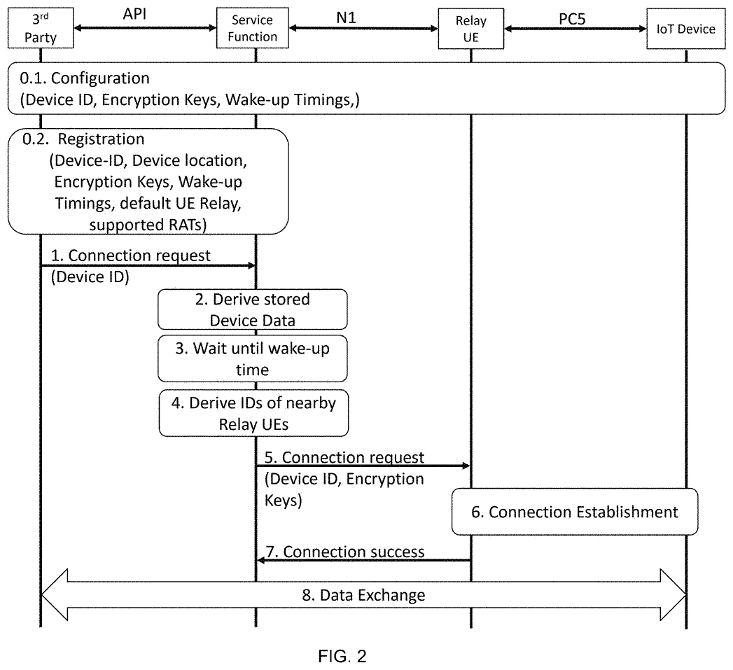

FIG. 2 is a sequence chart showing steps in the execution of the invention.

In FIG. 1 the architecture of a 5G UE to network relay is enhanced with an API to share data needed to orchestrate an opportunistic UE to network relay scenario in order to establish a logical link between an IoT device and the corresponding IoT application.

The PLMN architecture is depicted as a 5G cellular network divided into the core network as a functional block element and the radio access network (RAN), that consists in this figure of a single base station gNB. The interface between the base station gNB and the core network is named N2. The logical link between the core network and relay UEs is named N1. The air interface in 5G is named new radio (NR). A device to device interface between a relay UE and an IoT device is named a “sidelink” or PC5. Entities within a rectangular box 20 belong to the domain of the PLMN. Entities outside of the box 20 belong to the domain of the IoT service provider. The logical link between an IoT device and the application server of the IoT service provider crosses borders between both domains.

The API in this embodiment is between the 5G core network and one or more 3^{rd} party IoT service providers 22 depicted as a single block entity.

The API, e.g. a web-based API, enables a service function of the core network to query data from the 3^{rd} party IoT service provider. At least a device ID, e.g. MSISDN and the position of the IoT-device, e.g. GPS coordinates, is transferred to the PLMN operator to orchestrate one or more relay UEs. Additional ProSe discovery and sidelink information (e.g. time and frequency of the resources that are monitored by the IoT-device) could accelerate the establishment of the sidelink. If one or more cellular phone numbers of the IoT users or residents of the building with smart meters are known, the IoT service provider could transfer the numbers to the PLMN operator, because it is likely that these UEs will get in proximity with the IoT device.

Further, the API enables the 3^{rd} party IoT service provider to connect to the IoT device or to receive certain data (e.g. current meter value) from the IoT device upon request, event driven (e.g. if the meter value exceeds a certain value) or regularly.

In a first embodiment the waterworks of a larger city has deployed thousands of smart meters measuring water consumption in almost all residential buildings all over town. These water meters could be placed in different locations such as in an outside cabinet, under a service cover or inside a home, for example in a basement. Because of the deployment of smart meters, the waterworks can reduce the operational costs.

For a simple installation, all smart meters are battery-powered and enabled for cellular mobile network connection including the relayed sidelink connections. There are a significant number of smart meters without or with insufficient cellular connectivity but there are relay UEs nearby which have the ability to relay the connection from the smart meters to the core network. Many residents would not be participating or would not even have the technical requirements to participate in an OTT application-based solution to extend the coverage by using their relay UE. Therefore, instead of any OTT solution the waterworks use a new service described herein of “opportunistic UE to network relaying” OUNR of a PLMN operator (the same operator to which the IoT devices are subscribed) in order to establish an indirect connection to the smart meter transparently (i.e. without user interaction) using resident's relay UEs or other relay UEs in proximity as a UE to network relay for energy efficiency and extensive coverage. The waterworks are aware of the position and configurations of these smart meters. In order to save battery power, the smart meters have switched off their communication unit most of the time and they are waking up the radio transceiver (e.g. for monitoring the cellular link (e.g. the paging channel) and/or sidelink (e.g. discovery signals) and/or to send out a beacon for indirect (sidelink) communication) e.g. only once a day. The exact timing of these wake-up phases as well as all other communication configurations (e.g. encryption keys) of the IoT device are well known by waterworks, e.g. they were configured by the waterworks prior to installation at the customer.

A PLMN operator with a well deployed cellular network in this area offers the OUNR service to the waterworks. The website of the cellular operator includes an API for configuring the opportunistic relaying service. An employee of the waterworks logs into the website, authenticates herself by entering username and password, and registers either the already deployed smart meters with insufficient or no cellular coverage, or all newly installed smart meters irrespective of the coverage conditions at the customer. For each smart meter the employee enters the exact position with GPS coordinates, the time window in which the smart meter will be able to establish indirect communication and all configuration data needed for ProSe discovery and sidelink establishment by a potential UE to network relay or chain of relays. Also an address of one or more servers for IoT services is entered as target for each smart meter to the API.

On the other side the PLMN operator provides statistics about the availability of indirect communication per registered IoT device. With these statistics the waterworks employee can optimize the configuration e.g. the time windows for indirect connections.

The smart meter related information entered to the API are transferred to the core network. The core network monitors UEs in proximity of the listed smart meters. If one or more UEs is within the given time window in proximity with a smart meter configured for the opportunistic relaying service, the UEs can be configured to measure the sidelink quality of service to the smart meter and report link quality to the network. The network selects a UE in proximity to the smart meter or a chain of relay UEs to be configured to establish a sidelink to the smart meter using provided configuration data for a fast sidelink establishment. For the relay UE selection parameters such as UE capabilities, service authorization, subscription, data traffic, user consent, sidelink quality of service, battery power and more parameters should be considered. The selected relay UE is configured to establish a sidelink connection to the smart meter. The sidelink connection establishment could be initiated by the smart meter as remote UE or by the relay UE. In both case the bilateral discovery and sidelink establishment parameters are sent to the relay UE. Once the sidelink is established the UE may be configured to acknowledge the sidelink establishment to the network.

The indirect connection of the smart meter to the cellular network via relay UE or chain of relay UEs can be used to establish a connection between the smart meter as an IoT device and the IoT server of the waterworks as a 3^{rd}-party IoT service provider. This connection could be initiated by the IoT device or by the IoT application server. The relay UE selection and the configured relay UEs are transparent to the IoT service provider. The indirect connection between IoT device and cellular network is offered to the 3^{rd}-party IoT provider as a transparent service. Network and IoT device should be securely connected; e.g. encryption and integrity protection, in order to proxy the data thru a chain of relay UEs without revealing any information about the IoT device or the device owner.

FIG. 2 shows a procedure to obtain connection via a relay UE to the IoT device comprising the following steps:
0.1—The 3^{rd} party IoT service provider configures the IoT device with a device ID, encryption keys and wake-up timings.
0.2—The 3^{rd} party IoT service provider registers the IoT device for the service at the service function. Therefore, it delivers following parameters via the API to the service function: device-ID, device location, encryption key (for the radio interface, e.g. PC5), wake up timings, default relay UE (if any) and supported radio access technologies (RATs) (only in case, that more than one RAT is supported. The wake-up timings and encryption keys can be set individually per RAT). The data are stored by the service function.
1—The 3^{rd} party IoT service provider wants to obtain data from the IoT device. Therefore, it transmits a connection request for the related device-ID.
2—The service function loads the stored data for the device according to the received device-ID.
3—The service function waits until the next wake-up time according to the loaded data.
4—Shortly prior to wake-up time, the service function derives information about nearby relay-UEs, that are willing to enable a relay connection to the device.
5—The service function instructs the relay UEs (e.g. one after another) to connect to the IoT device. It therefore transmits the device ID and encryption keys to the relay UE.
6—The relay UE connects to the IoT device. It starts the connection establishment either by transmitting a discovery message to the IoT device or by listening to a discovery message send by the IoT device. Which method to use is either pre-configured or included in the connection request message sent by the service function.
7—If the connection is successful, the relay UE transmits a connection success message to the service function.
8—If a connection success message is received by the service function, it informs the 3^{rd} party and forwards the data. If no or a negative connection success message is received, steps 5 to 7 are repeated by another relay UE obtained in step 4, until the connection is successful or no more relay UEs are available. In another embodiment, steps 5 to 7 are executed simultaneously by multiple relay UEs. The service function will select the best suited relay UE, if multiple connection success messages are received.

1. A method of selecting a user equipment, UE, device (UE1, UE2, UE3) to act as a relay between an internet connected server and a remote UE device, the method characterized by comprising:
at a time determined by a knowledge of when the remote UE device will enter an active state identifying one or more UE devices in a vicinity of a known location of the remote UE device which are able to act as relay devices;
selecting one or more of the identified UE devices to establish a connection with the remote UE device; and
instructing the one or more selected UE devices to establish a connection with the remote UE device to provide the relay.

2. The method according to claim 1, wherein the step of instructing includes providing an identifier of the remote UE device.

3. The method according to claim 1, wherein the step of instructing includes providing an encryption key.

4. The method according to claim 1, wherein the step of selecting includes receiving from the one or more UE devices in the vicinity of the remote UE device a measure of communication quality with the remote UE device.

5. The method according to claim 1, wherein the method is performed by an entity of a public land mobile network.

6. The method according to claim 1, wherein the remote UE device is an internet-of-things device.

7. The method according to claim 1, wherein the remote UE device is a smart meter.

8. The method according to claim 1, wherein the internet connected server is operated by a service provider and wherein the remote UE device has configuration settings known to the service provider.

9. The method according to claim 8, wherein the method is performed by an entity of a public land mobile network, wherein the service provider provides an operator of the public land mobile network with information about the configuration settings.

10. The method according to claim 1, wherein the connection with the remote UE device is a sidelink connection.

11. The method according to claim 2, wherein the step of instructing includes providing an encryption key.

12. The method according to claim 2, wherein the step of selecting includes receiving from the one or more UE devices in the vicinity of the remote UE device a measure of communication quality with the remote UE device.

13. The method according to claim 3, wherein the step of selecting includes receiving from the one or more UE devices in the vicinity of the remote UE device a measure of communication quality with the remote UE device.

14. The method according to claim 2, wherein the method is performed by an entity of a public land mobile network.

15. The method according to claim 2, wherein the remote UE device is an internet-of-things device.

16. The method according to claim 2, wherein the remote UE device is a smart meter.

17. The method according to claim 2, wherein the internet connected server is operated by a service provider and wherein the remote UE device has configuration settings known to the service provider.

18. The method according to claim 17, wherein the method is performed by an entity of a public land mobile network, wherein the service provider provides an operator of the public land mobile network with information about the configuration settings.

19. The method according to claim 4, wherein the internet connected server is operated by a service provider and wherein the remote UE device has configuration settings known to the service provider.

20. The method according to claim 2, wherein the connection with the remote UE device is a sidelink connection.
